(19) United States
(12) Patent Application Publication
(10) Pub. No.: US 2023/0127532 A1
(43) Pub. Date: Apr. 27, 2023

(54) Control Plate for an Axial Piston Machine, and an Axial Piston Machine comprising a Control Plate

(71) Applicant: Robert Bosch GmbH, Stuttgart (DE)

(72) Inventors: David Breuer, Tuebingen (DE); Sebastian Birk, Sulz (DE); Stefan Haug, Neu-Ulm (DE); Stefan Hoppe, Sulz A.N. (DE); Timo Nafz, Horb (DE)

(21) Appl. No.: 17/965,441

(22) Filed: Oct. 13, 2022

(30) Foreign Application Priority Data
Oct. 27, 2021 (DE) 10 2021 212 096.2

(51) Int. Cl. F04B 1/2078

(52) U.S. Cl. CPC F04B 1/2078

(57) ABSTRACT

A control plate for an axial piston machine is disclosed. The control plate includes a control face on which at least one kidney-shaped high-pressure control opening extending axially through the control plate and at least one kidney-shaped low-pressure control opening extending axially through the control plate is formed and which defines a first sealing ridge which is formed radially inside the at least one high-pressure control opening and the at least one low-pressure control opening, and a second sealing ridge which is formed radially outside the at least one high-pressure control opening and the at least one low-pressure control opening. In this case, the second sealing ridge is wider in the radial direction, preferably in some portions, than the first sealing ridge. Additionally, an axial piston machine in a swash plate design is disclosed. The axial piston machine includes a control plate which has at least one kidney-shaped high-pressure control opening and at least one kidney-shaped low-pressure control opening, by way of which piston recesses of a cylinder drum which is rotatably mounted in a housing of the axial piston machine can be connected alternately to a high-pressure connection and a low-pressure connection during rotation of the cylinder drum. In this case, a first, radially inner sealing ridge and a second, radially outer sealing ridge, which is designed to be wider in the radial direction, preferably in some portions, than the first sealing ridge, are formed on a contact face between the control plate and the cylinder drum.

This application claims priority under 35 U.S.C. § 119 to Patent Application No. DE 10 2021 212 096.2, filed on Oct. 27, 2021 in Germany, the disclosure of which is incorporated herein by reference in its entirety.

The disclosure relates to a substantially annular-disk-shaped control plate/distributor plate for or of an axial piston machine, and to an axial piston machine.

### BACKGROUND

In conventional axial piston machines, pistons which are arranged in a longitudinally displaceable (axially displaceable) manner in cylinder bores of a cylinder drum which is rotatably accommodated in a housing, pistons perform a stroke movement, that is to say a suction stroke and a discharge stroke, during each rotation of the cylinder drum. For this purpose, the pistons slide on the head side on a disk which is oriented at a slant with respect to the axis of rotation of the cylinder drum, by way of which a rotational movement of the cylinder drum is transformed into an axial movement of the piston mounted therein. For a rotor synchronous connection between the cylinder drum and operating lines of the axial piston machine, on an end face of the cylinder drum facing away from the slanted disk, an annular-disk-shaped control/distributor plate/control disk is inserted in the housing which, by way of kidney-shaped control openings/control inlets/outlets arranged on a circular path, allows the connection of the cylinder drum, that is to say of the cylinder bores formed therein, to a high-pressure connection or a low-pressure connection. By way of the design of the control plate, in particular by way of the arrangement and dimensions of the control openings, the operating characteristics of the axial piston machine can be adjusted and optionally changed by replacing the control plate.

For the (sliding) sealing of the connection between the cylinder drum and the control plate, what are known as sealing ridges are conventionally formed/arranged on the control plate between the control openings or surrounding the control openings. In other words, the cylinder drum is in (frictional/sliding) contact with the sealing ridges of the control plate. The sealing ridges must have a high surface quality in order to ensure such a high sealing effect and prevent or minimize leakage over a long period of time. Conventionally, the sealing ridges are formed with a constant outside and constant inside diameter.

Thus for example in DE 10 2012 105 302 A1, a control plate of an axial piston machine is shown with conventional control openings, that is to say control openings which are uniform in the radial and circumferential direction and/or with conventional sealing ridges, that is to say sealing ridges which are circular with respect to the inner and outer contours thereof.

Furthermore, EP 1 590 569 B1 discloses a non-circular control plate for a conventional axial piston machine. In this case, control openings of the control plate are each distributed in a uniform manner on a high-pressure and a low-pressure side of the control plate. In other words, the control openings are formed in a uniform manner on a side of the control plate which is connected to a high-pressure connection when installed, and on a side of the control plate which is connected to a low-pressure connection. In this case, the sealing ridges have a circular design with respect to the inner and outer contours thereof.

DE 43 40 061 C2 shows another example of a control plate of a conventional axial piston machine. In this case, the control plate comprises control openings and/or sealing ridges having various radial spacings from an axis of rotation of the cylinder drum and/or various dimensions. An asymmetrical pressure field can thus be generated, which in turn generates a compensation torque which counteracts a tilting torque of the cylinder drum which is produced during the operation of the axial piston machine.

Similarly, DE 10 2005 021 029 A1 also shows an axial piston machine in a swash plate design, on the control plate of which asymmetrical pressure fields are generated to compensate for the tilting torque. For this purpose, the control plate comprises control openings having cross sections of different sizes which increase and decrease over the circumference.

### SUMMARY

By contrast, the invention addresses the problem of optimizing a control plate for an axial piston machine or optimizing an axial piston machine.

The problem is solved according to the disclosure by a control plate having the features described below and an axial piston machine having the features described below. Advantageous developments of the disclosures are also described below.

In one particularly preferred embodiment of the control plate according to the disclosure, the second sealing ridge is wider in the radial direction in the region of the at least one high-pressure control opening than the first sealing ridge. The control openings can thus be displaced radially inward as far as possible, which in turn allows high rotational speeds of the cylinder drum as a result of the lower centrifugal forces. Furthermore, it is thus ensured that a comparatively cost-effective axial piston machine having greater strain relief and reduced tilting torque is provided. In addition, overloading of the (frictional) contact between the cylinder drum and the control plate can be prevented. Of course in this case it can be expedient to provide additional sealing ridges, i.e. a plurality of sealing ridges, which differ from one another in terms of the radial extent thereof, i.e. the width thereof in the radial direction.

Preferably, the second sealing ridge can have a radial extent in the region of the at least one high-pressure control opening. Thus, in a locally limited manner, a higher pressure-relief force can be generated, which further increases the strain relief.

According to one advantageous development, the control plate can comprise, in the radial direction (from the point of view of wall thicknesses), a first portion, a second portion and a third portion, wherein the second portion can have a greater thickness than the first portion and the third portion.

In this case, it can additionally be advantageous for the control face, i.e. the control openings and the sealing ridges, to be formed on the second portion. Of course the control plate can also comprise a plurality of portions having different thicknesses. It is thus conceivable for example for the control plate to have four portions, i.e. two portions having a greater thickness and two portions having a smaller thickness. In this case, it can also be expedient for the thicknesses of the portions to be different with a greater or smaller thickness.

For the sealing between the cylinder drum and the control plate, in general, a contact face having a high surface quality is necessary, which results in expensive and time-consuming secondary machining steps, such as lapping. By way of the development mentioned above, the requirement for high surface quality and consequently for the surface to undergo secondary machining can be limited to the second portion.

In another preferred embodiment, a plurality of, in particular four, high-pressure control openings having different dimensions can be provided. The individual kidney-shaped control openings which are arranged at a distance from one another on the circumference of a circular path can differ from one another in particular in terms of the extent thereof in the circumferential direction of the control plate. By way of the individual dimensioning of the control openings, the operating characteristics of the axial piston machine can be adjusted.

The present disclosure further relates to an axial piston machine, preferably in a swash plate design, comprising a control plate which has at least one kidney-shaped high-pressure control opening extending axially through the control plate, and at least one kidney-shaped low-pressure control opening extending axially through the control plate. By way of the control openings, piston bores/recesses of a cylinder drum which is rotatably mounted in a housing of the axial piston machine can be/are connected alternately to a high-pressure connection and a low-pressure connection during rotation of the cylinder drum. In this case, a first, radially inner sealing ridge and a second, radially outer sealing ridge which is designed so as to be wider in the radial direction, preferably in some portions, than the first sealing ridge, are formed on a contact region between the control plate and the cylinder drum.

In this case it can be advantageous for the first sealing ridge and the second sealing ridge to be formed on the control plate according to the disclosure. Alternatively, the first sealing ridge and the second sealing ridge can also be formed on an end face of the cylinder drum which is in contact with the control plate. In other words, the variable sealing ridge width according to the disclosure can be defined both by the control plate and on the cylinder drum.

### BRIEF DESCRIPTION OF THE DRAWINGS

In the following, one preferred exemplary embodiment of an axial piston machine comprising a control plate according to the disclosure will be described in greater detail with reference to the accompanying drawings, in which:

FIG. 1 is a longitudinal sectional view of an axial piston machine,

FIG. 2 is a perspective view of a cylinder drum according to the disclosure according to one preferred exemplary embodiment, and

FIG. 3 is a perspective view of a control plate according to the disclosure according to the preferred exemplary embodiment.

### DETAILED DESCRIPTION

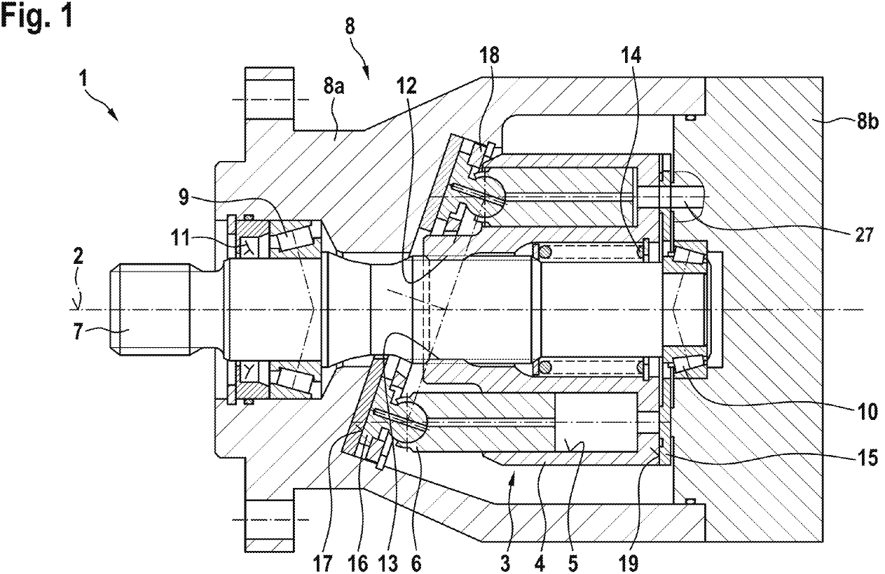

FIG. 1 is a longitudinal sectional view of an axial piston machine 1. In this case, the axial piston machine 1 is in the form of a pump or motor in a swash plate design. The axial piston machine 1 comprises a drive mechanism assembly 3 which is arranged so as to be able to rotate about an axis of rotation 2 and which has a cylinder drum 4 which is provided with a plurality of piston recesses 5 arranged concentrically with a central axis of rotation 2, preferably in the form of cylinder bores. One piston 6 is mounted in a longitudinally displaceable manner in each of the piston recesses 5.

Furthermore, the drive mechanism assembly 3 comprises a drive shaft 7 which is guided through an opening/bore in the cylinder drum 4 concentrically with the central axis of rotation 2.

The drive shaft 7 and consequently the drive mechanism assembly 3 are further rotatably accommodated in a housing 8 of the axial piston machine 1. The housing 8 in turn consists of two housing parts which are axially screwed to one another and which together define a receiving cavity for the drive mechanism assembly 3. In the exemplary embodiment shown in FIG. 1, the housing 8 is specifically composed of a housing pot 8a and a corresponding housing lid 8b, and therefore the hollow or receiving cavity is thus formed in the housing interior to receive the drive mechanism assembly 3, and the drive shaft 7 extends through an opening in the housing pot 8a formed concentrically with the axis of rotation 2 on an outer face of the housing 8.

In order to support the drive mechanism assembly 3 or the drive shaft 7 supporting this assembly in a rotationally fixed manner, two bearing points 9, 10 in the form of tapered roller bearings are arranged.

In this case, a bearing point 9 is arranged in the region of the above-mentioned opening for the feedthrough of the drive shaft 7 in the housing pot 8a, whereas the other bearing point 10 is formed in the housing lid 8b. In order to seal the housing 8, a sealing element in the form of a radial shaft sealing ring 11 is additionally arranged in the region of the one bearing point 9.

As shown in FIG. 1, the cylinder drum 4 comprises an inner toothing 12 which is engaged with an outer toothing 13 formed on the drive shaft 7. In other words, the cylinder drum 4 is connected to the drive shaft 7 in a rotor-synchronous but axially displaceable manner. Furthermore, the drive mechanism assembly 3 comprises a spring 14 in the form of a (helical) compression spring 14 which prestresses the cylinder drum 4 against the drive shaft 7 in such a way that the cylinder drum 4 is pressed towards the housing lid 8b relative to the drive shaft 7 in order to hold a control plate 15, which is described in greater detail below and is arranged in a direction of the central axis of rotation (axial direction) between the cylinder drum 4 and the housing lid 8b, in contact with the housing lid 8b. In other words, the spring 14 is designed to press the control plate 15 against the housing lid 8b by way of the cylinder drum 4.

The pistons 6 mentioned above are each connected at the end portion (piston head) thereof facing away from the housing lid 8b by way of a ball joint to a support element 16 in the form of a sliding block and are supported on a swash plate 17 by way of these support elements 16. The swash plate 17 which is at a slant relative to the axis of rotation 2 can be integrally formed on the housing 8 or fastened thereto in a rotationally fixed manner so that the axial piston machine 1 has a fixed displacement volume. However, it is also conceivable to design the swash plate 17 to have an adjustable inclination with respect to the axis of rotation 2, by way of which the displacement volume of the axial piston machine 1 can be made adjustable/variable.

The support elements 16 formed by the sliding blocks are pressed against the swash plate 17 by an annular-disk-shaped hold-down plate 18, which rotates together with the cylinder drum 4 but is held by the housing by way of a shaft ring and is thus prevented from lifting off from the swash plate 17.

In the exemplary embodiment shown, an end face of the cylinder drum 4 is supported on a control face 19 fixed to the housing in the direction of the axis of rotation. In this case, the control face 19 is formed on the control plate 15. The above-mentioned control plate 15 shown in isolation in FIG. 3 is in turn held on the housing lid 8b in a rotationally fixed manner.

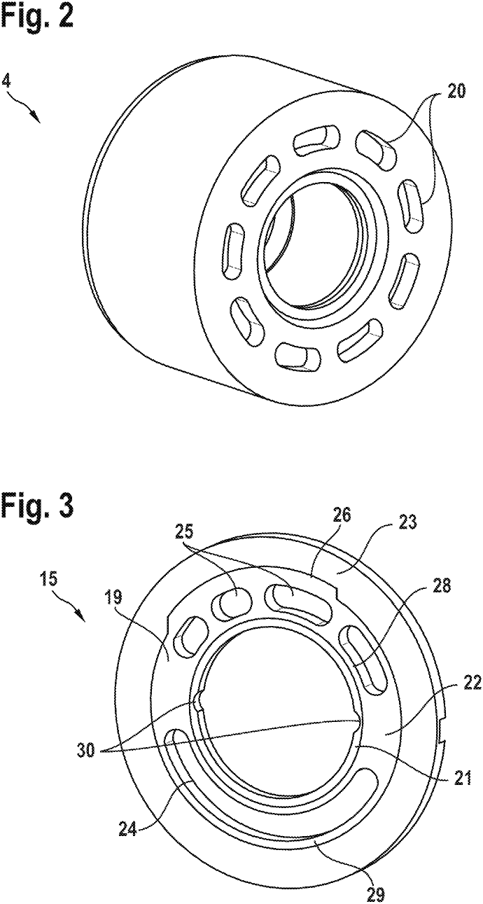

As shown in FIG. 2, the cylinder drum 4 comprises, on the end face thereof which is in contact with the control plate 15, kidney-shaped connecting openings 20 distributed over the circumference, which are each assigned to a piston recess 5. In other words, one connecting opening 20 is formed for each piston recess 5.

FIG. 3 shows the control plate 15 according to the preferred exemplary embodiment. The control plate 15 designed with a preferably circular outer contour has, in the radial direction from the inside outward, a first portion 21, a second portion 22 and a third portion 23, wherein the plate thickness/material thickness of the first portion 21 and the third portion 23 is smaller than the plate thickness of the second portion 22. In other words, the second portion 22 is formed in the manner of a planar projection and protrudes in the axial direction from the first portion 21 and the third portion 23.

Furthermore, the control plate 15, as shown in FIG. 3, comprises a low-pressure control opening/control nodule 24 and at least one, in particular four, high-pressure control openings/control nodules 25. In other words, in the control plate 15, the low-pressure control opening 24 is formed on a low-pressure side (at the bottom of FIG. 3), and the four high-pressure control openings 25 are formed on a high-pressure side (at the top of FIG. 3). The low-pressure control opening 24 and the high-pressure control openings 25 are in the form of kidney-shaped through-openings, wherein in the preferred exemplary embodiment, the size, that is to say the extent in the circumferential direction, of the high-pressure control openings 25 varies. In particular, in this case, two of the high-pressure control openings 25 are smaller than the two other high-pressure control openings 25.

As shown in FIG. 3, the second portion 22 has, on the high-pressure side, i.e. in the region of the high-pressure control openings 25, an extension (cam) 26 protruding in the radial direction and extending in the circumferential direction, so that, in the region of the extension 26, the second portion 22 has a greater width in the radial direction. As a result of the widening of the second portion 22 on the high-pressure side, the higher mechanical load in this region can be better compensated for. In addition, in this region, a higher pressure-relief force can be generated in a locally limited manner. By way of this local increase, the strain relief can be increased, and the radius of the residual force can simultaneously be reduced (especially locally at the extreme value). If the widening 26 were to extend over a greater region, the application point of the residual force would migrate further outward in the radial direction. As a result, the pressure-relief force increases again, but the cylinder drum 4 tends to tilt much more quickly.

If the cylinder drum 4, as mentioned previously, is then pressed against the control plate 15 and the housing lid 8b by the spring 14, the end face of the cylinder drum 4 comes into contact exclusively with the second portion 22 of the control plate 15. During rotation of the drive shaft 3 and consequently the cylinder drum 4, the piston recesses 5 selectively come into fluid contact, via the connecting openings 20 and the low-pressure control opening 24 and the high-pressure control openings 25, with a high-pressure connection/inlet side, for example in the form of a suction duct 27, and a low-pressure connection/outlet side (not shown in FIG. 1).

During operation, the connections/fluid ducts between the piston recesses 5 and the inlet or outlet side must be sealed. At the same time, in order to reduce the frictional resistance between the rotating cylinder drum 4 and the control plate 15 fixed to the housing, a lubricating film is to be produced. For this purpose, the control plate 15 and in particular the control face 19 must have a high surface quality. Because only the second portion 23 of the control plate 15 is in contact with the cylinder drum 4, i.e. only the second portion 23 forms the control face 19, it is also only necessary to refinish this portion 23 separately, for example by additional lapping, to ensure the high surface quality.

As mentioned previously, during operation, the second portion 23 must ensure sealing between the cylinder drum 4 and the control plate 15. In other words, the second portion 23 forms a first, radially inner sealing ridge 28, and a second, radially outer sealing ridge 29, wherein the low-pressure control opening 24 and the high-pressure control openings 25 are formed in the radial direction between the first sealing ridge 28 and the second sealing ridge 29. As shown in FIG. 3, in this case the width of the first sealing ridge 28 is constant over the entire circumference, whereas the second sealing ridge 29 has a smaller width on the low-pressure side than on the high-pressure side. As mentioned previously, the second sealing ridge 29 forms the extension 26 on the high-pressure side. Because the first sealing ridge 28 has a constant width over the entire circumference, the low-pressure control opening 24 and the high-pressure control openings 25 are displaced in the radial direction inward as far as possible, which reduces the centrifugal forces into the control openings 24, 25 and thus allows high rotational speeds.

According to the preferred exemplary embodiment, the control plate 15 is fixed to the housing 8 in a stationary manner. In addition, the inner circumference of the control plate 15 is supported on an outer bearing ring of the bearing point 10. Furthermore, the control plate 15 comprises a plurality of, in particular two grooves 30 on the inner circumference thereof, which grooves are used for example for centering with a centering element, in particular an alignment pin, fixed to the bearing ring of the bearing point 10, and/or for discharging leakage oil out of the region of the spring 14.

In the preferred exemplary embodiment described previously, the sealing ridges 28, 29 are formed on the control face 19 of the control plate 15, and the end face of the cylinder drum 4 has a planar design. Of course the end face of the cylinder drum 4 can also comprise the sealing ridges 28, 29, and the control face 19 of the control plate 15 can have a planar design.

A control plate for an axial piston machine in a swash plate design is disclosed, comprising a control face which has at least one kidney-shaped high-pressure control opening and at least one kidney-shaped low-pressure control opening, by way of which piston recesses of a cylinder drum rotatably mounted in a housing of the axial piston machine can be alternately connected to a high-pressure connection and a low-pressure connection during rotation of the cylinder drum, and a first sealing ridge which is formed radially inside the at least one high-pressure control opening and the at least one low-pressure control opening, and a second sealing ridge formed radially outside the at least one high-pressure control opening and the at least one low-pressure control opening. In this case, the second sealing ridge is wider in the radial direction, preferably in some portions, than the first sealing ridge.

Additionally, an axial piston machine in a swash plate design is disclosed, comprising a control plate which has at least one kidney-shaped high-pressure control opening and at least one kidney-shaped low-pressure control opening, by way of which piston recesses of a cylinder drum which is rotatably mounted in a housing of the axial piston machine can be connected alternately to a high-pressure connection and a low-pressure connection during rotation of the cylinder drum. In this case, a first, radially inner sealing ridge and a second, radially outer sealing ridge, which is designed so as to be wider in the radial direction, preferably in some portions, than the first sealing ridge, are formed on a contact face between the control plate and the cylinder drum.

What is claimed is:

1. A control plate for or of an axial piston machine, comprising:
a control face in which are formed (i) at least one kidney-shaped high-pressure control opening extending axially through the control plate, and (ii) at least one kidney-shaped low-pressure control opening extending axially through the control plate,
wherein the control face defines (i) a first sealing ridge which is radially inner relative to the at least one kidney-shaped high-pressure control opening and the at least one kidney-shaped low-pressure control opening, and (ii) a second sealing ridge which is radially outer relative to the at least one kidney-shaped high-pressure control opening and the at least one kidney-shaped low-pressure control opening, and
wherein the second sealing ridge is wider in the radial direction in at least some portions than the first sealing ridge.

2. The control plate according to claim 1, wherein the second sealing ridge is wider in the radial direction at least in the region of the at least one kidney-shaped high-pressure control opening than the first sealing ridge.

3. The control plate according to claim 1, wherein the second sealing ridge has a radially outwardly directed extension at least in the region of the at least one kidney-shaped high-pressure control opening.

4. The control plate according to claim 1, wherein:
in the radial direction, the control plate has a first portion, a second portion and a third portion, and
the second portion has a greater thickness in the axial direction than the first portion and the third portion.

5. The control plate according to claim 4, wherein the control face is formed in the second portion.

6. The control plate according to claim 1, wherein the at least one kidney-shaped high-pressure control opening includes a plurality of kidney-shaped high-pressure control openings having different dimensions.

7. An axial piston machine, comprising:
a housing;
a cylinder drum rotatably mounted in the housing; and
a control plate which has at least one kidney-shaped high-pressure control opening and at least one kidney-shaped low-pressure control opening, by way of which piston recesses of the cylinder drum are configured to be connected alternately to a high-pressure connection and a low-pressure connection during rotation of the cylinder drum,
wherein, on a contact face between the control plate and the cylinder drum, a radially inner, first sealing ridge and a radially outer, second sealing ridge are formed, which is wider in the radial direction, in some portions, than the first sealing ridge.

8. The axial piston machine according to claim 7, wherein the first sealing ridge and the second sealing ridge are formed on the control plate.

9. The axial piston machine according to claim 7, wherein the first sealing ridge and the second sealing ridge are formed on an end face of the cylinder drum in contact with the control plate.

10. The control plate according to claim 1, wherein the control face is an annular control face.

11. The control plate according to claim 1, wherein the second sealing ridge is wider in the radial direction exclusively in the region of the at least one kidney-shaped high-pressure control opening than the first sealing ridge.

12. The control plate according to claim 1, wherein the second sealing ridge has a radially outwardly directed extension exclusively in the region of the at least one high-pressure control opening.

13. The control plate according to claim 1, wherein the at least one kidney-shaped high-pressure control opening includes four kidney-shaped high-pressure control openings having different dimensions.

14. The axial piston machine of claim 7, wherein the axial piston machine possesses a swash plate design.
